(19) United States
(12) Patent Application Publication
(10) Pub. No.: US 2010/0045596 A1
(43) Pub. Date: Feb. 25, 2010

(54) DISCREET FEATURE HIGHLIGHTING

(75) Inventor: Richard David Claudius DE LEON, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/195,590

(22) Filed: Aug. 21, 2008

(51) Int. Cl. G06F 3/033; H04N 7/18

(52) U.S. Cl. 345/157; 348/78

(57) ABSTRACT

A device may identify a first graphical feature at which a viewer is looking, remove a highlight from the first graphical feature, identify at least one graphical feature to be highlighted based on a location at which the viewer is looking, and highlight the at least one graphical feature.

### BACKGROUND

Many of today's high tech consumer products incorporate a number of functionalities that may include one or more helpful features or help systems. However, because consumers generally do not explore the functionalities to their fullest extent, the consumers may not discover or use the helpful features/help systems.

In some situations, the consumers may resent and/or avoid using a help system that analyzes user behavior and predicts a user's next action (e.g., an office assistant). While the help system has the potential to benefit the user, such help systems may fail to account for the user's desire to resolve any issues by oneself. In other instances, the help systems may render wrong or untimely guesses as to what the user wants to accomplish (e.g., write a letter).

### SUMMARY

According to one aspect, a method may include identifying a first graphical feature at which a viewer is looking, removing a highlight from the first graphical feature, identifying at least one graphical feature to be highlighted based on a location at which the viewer is looking, and highlighting the at least one graphical feature.

Additionally, highlighting the at least one graphical feature may include at least one of rotating the graphical feature, translating the graphical feature, scaling the graphical feature, distorting the graphical feature, changing a color of the graphical feature, or underlining, italicizing, or bolding text of the graphical feature.

Additionally, the method may further include obtaining eye tracking data to determine the location, on a display, at which the viewer is looking.

Additionally, obtaining eye tracking data may include tracking eyes of the viewer via a camera.

Additionally, the method may further include determining whether the viewer is looking away from the first graphical feature, and removing highlights from the at least one graphical feature when the viewer is looking away from the first graphical feature.

Additionally, determining whether the viewer is looking away from the graphical feature may include determining whether the viewer is looking outside of a predetermined region in which the graphical feature lies, or determining whether viewer is at a point outside of the graphical feature.

Additionally, determining whether the viewer is looking outside of a predetermined region may include determining whether the viewer is looking at an outer fixation point inside the region.

Additionally, identifying at least one graphical feature to be highlighted may include at least one of determining whether one of plurality of graphical features can provide useful information to the viewer when the one of plurality of graphical features is activated, or determining whether one of plurality of graphical features is an advertisement.

Additionally, identifying a first graphical feature at which a viewer is looking may include determining whether the viewer's eyes are fixated or focused on a point within a predetermined region that includes the first graphical feature.

According to another aspect, a device may include a display and an application. The display may show one or more graphical features. The application may identify a graphical feature at which a viewer is looking, identify at least one graphical feature to which a highlight may be applied, and apply the highlight to the at least one graphical feature when the viewer looks away from the graphical feature.

Additionally, the device may include a cell phone, an electronic notepad, a laptop, a personal computer, or a portable digital assistant.

Additionally, the device may further include at least one of a front camera to track the viewer's eyes, or a sensor to measure a distance between the device and the viewer's eyes.

Additionally, the graphical feature may include at least one of text, an icon, an image, a menu item, or a link.

Additionally, the application may include a browser.

Additionally, the application may be further configured to undo a highlight on the graphical feature.

Additionally, the application may be further configured to apply highlights to one or more graphical features when the viewer is looking at the graphical feature.

Additionally, the device may further include eye tracking logic to obtain a location, on the display, of a point at which the viewer looks.

According to yet another aspect, a method may include obtaining eye tracking data, obtaining a location at which a viewer is looking based on the eye tracking data, identifying a component at which a viewer is looking based on the location at which the viewer is looking, removing a highlight from the component, identifying at least one component to be highlighted based on viewer activity or the eye tracking data, determining whether the viewer is looking away from the component; and removing highlights from the at least one component when the viewer is looking away from the component.

Additionally, the component may include an emergency exit or a billboard.

Additionally, obtaining eye tracking data may include obtaining head tracking data.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a diagram illustrating concepts described herein;

FIGS. 2A and 2B are front and rear views of an exemplary device that implements the concepts described herein;

FIG. 3 is a block diagram of the device of FIGS. 2A and 2B;

FIG. 4 is a functional block diagram of the device of FIGS. 2A and 2B;

FIG. 5 illustrates an operation of eye movement detection logic of FIG. 4;

FIG. 6 is a flow diagram of an exemplary process for discreetly highlighting a feature;

FIGS. 7A and 7B are diagrams illustrating the process of FIG. 6; and

FIG. 8 is a diagram depicting a browser that discreetly highlights an advertisement.

### DETAILED DESCRIPTION

The following detailed description refers to the accompanying drawings. The same reference numbers in different drawings may identify the same or similar elements. As used herein, the term “highlighting” may refer to applying a visual effect to or about a object (e.g., a button, switch, a graphical object (e.g., an icon), etc.). For example, assume that a device includes light emitting diodes (LEDs) that are distributed about a component of a hand-held device. Some of the LEDs may blink and/or change illumination patterns to draw a user's attention to the component.

In some instances, “highlighting” may refer to applying a graphical effect to a graphical object (e.g., text, an image, an icon, a menu item, a link, etc.) on a display screen. Applying the graphical effect (e.g., changing a color, orientation, size, underlining text, spot-lighting or highlighting via a window, flashing, changing or adding graphical effect close or about the graphical object, etc.) to or about the graphical object may cause the graphical object to be more noticeable. For example, animations moving toward the graphical object may cause the graphical object to be more noticeable. As used herein, the term “graphical feature” may refer to an image, icon, text, picture, and/or any element that may be shown on a display (e.g., a computer display).

In the following, a device may discreetly highlight a component. Although the component may be any component that may be visually perceived, in the following discussion, the component will be described as a graphical feature.

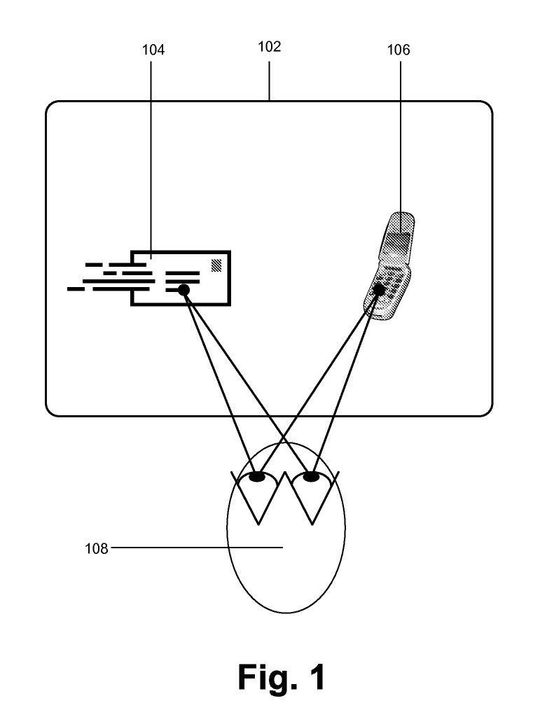

FIG. 1 illustrates the concept. As shown in FIG. 1, the device may include a display 102, which shows graphical feature 104 and graphical feature 106. Depending on the implementation of the device, display 102 may show additional or different graphical features than those illustrated in FIG. 1.

Each of graphical features 104 and 106 may include a graphical image, text, etc., that may convey visual information, or a graphical image (e.g., icon, a link, etc.) that may be activated via a mouse, a touch pad, a touch screen, etc., to start a software application or to cause the device to behave in a particular manner (e.g., place a phone call).

In FIG. 1, when viewer looks at graphical feature 104, graphical feature 106 may distract viewer 108 or discreetly vie for viewer 108's attention. Within viewer 108's peripheral field of vision, graphical feature 106 may move, vibrate, or show other visual effects. In some instances, other graphical elements surrounding graphical feature 106 may draw the viewer's attention. Consequently, viewer 108 may notice, consciously or subconsciously, graphical feature 106. When viewer 108 turns viewer's eyes toward graphical feature 106 in response, graphical feature 106 may stop displaying the visual effects.

In FIG. 1, by discreetly highlighting a feature, the device may draw attention to certain areas of a display without detection. The user may have a sense that something has been highlighted, but may be unable to confirm such is the case. By drawing the user's attention discreetly, the device may place the user in a better position to explore unobtrusive suggestions and/or helpful hints, perhaps with higher frequency.

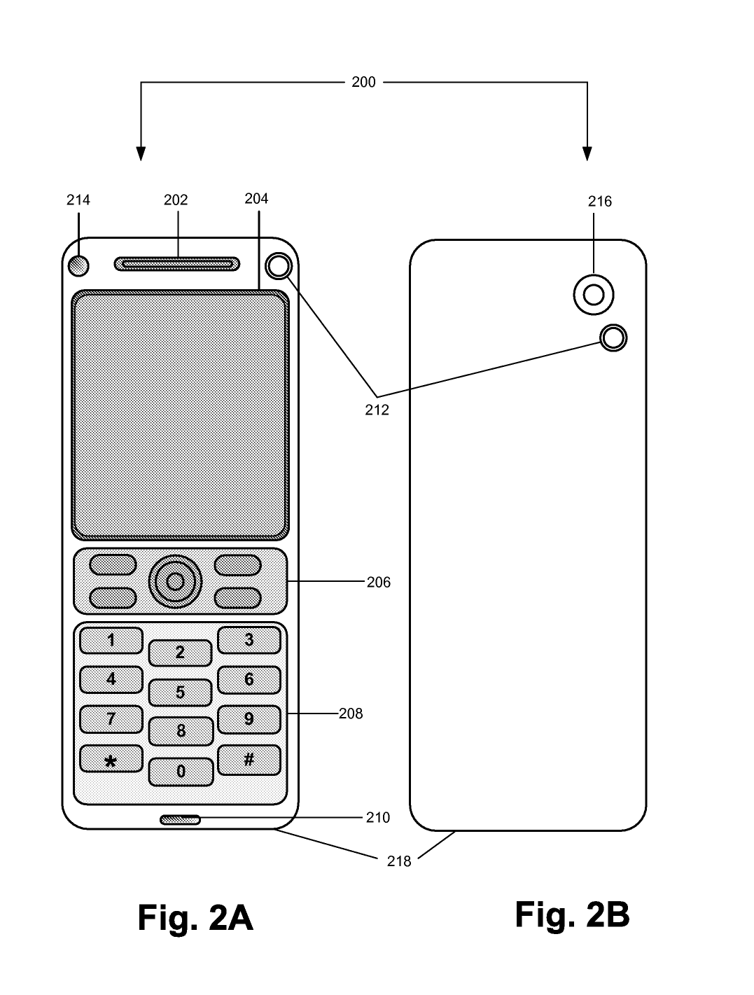

FIGS. 2A and 2B are front and rear views, respectively, of an exemplary device in which the concepts described herein may be implemented. Device 200 may include any of the following devices: a mobile telephone; a cell phone; a personal communications system (PCS) terminal that may combine a cellular radiotelephone with data processing, facsimile, and/or data communications capabilities; an electronic notepad, a laptop, and/or a personal computer; a personal digital assistant (PDA) that can include a telephone; a gaming device or console; a peripheral (e.g., wireless headphone); a digital camera; or another type of computational or communication device.

In this implementation, device 200 may take the form of a portable phone (e.g., a cell phone). As shown in FIGS. 2A and 2B, device 200 may include a speaker 202, a display 204, control buttons 206, a keypad 208, a microphone 210, sensors 212, a front camera 214, a lens assembly 216, and a housing 218. Speaker 202 may provide audible information to a user of device 200. Display 204 may provide visual information to the user, such as an image of a caller, video images, or pictures. Control buttons 206 may permit the user to interact with device 200 to cause device 200 to perform one or more operations, such as place or receive a telephone call. Keypad 208 may include a standard telephone keypad. Microphone 210 may receive audible information from the user. Sensors 212 may collect and provide, to device 200, information (e.g., acoustic, infrared, etc.) that is used to aid the user in capturing images or in providing other types of information (e.g., a distance between a user and device 200).

Front camera 214 may enable a user to view, capture and store images (e.g., pictures, video clips) of a subject in front of device 200, and may be separate from lens assembly 216 that is located on the back of device 200. In addition, front camera 214 may provide images of user's eyes to device 200 for eye tracking. Device 200 may use eye tracking to identify a location, on display 204, at which the user looks.

Lens assembly 216 may include a device for manipulating light rays from a given or a selected range, so that images in the range can be captured in a desired manner. Housing 218 may provide a casing for components of device 200 and may protect the components from outside elements.

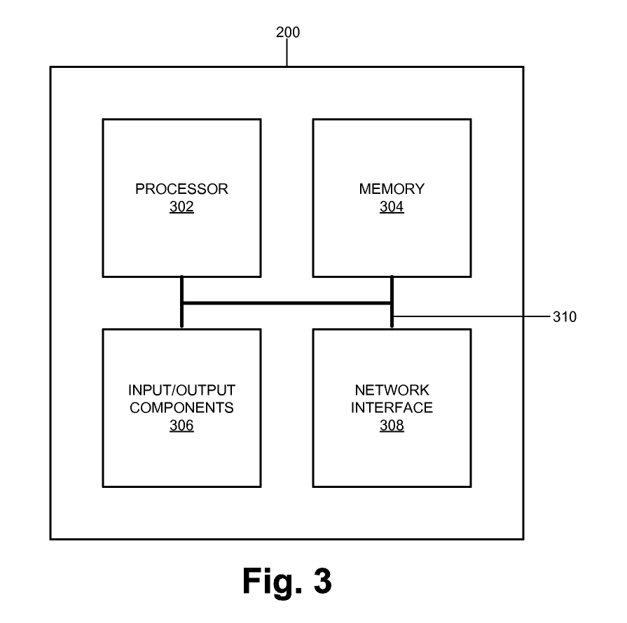

FIG. 3 is a block diagram of the device of FIGS. 2A and 2B. As shown in FIG. 3, device 200 may include a processor 302, a memory 304, input/output components 306, a network interface 308, and a communication path 310. In different implementations, device 200 may include additional, fewer, or different components than the ones illustrated in FIG. 2. For example, device 200 may include additional network interfaces, such as interfaces for receiving and sending data packets.

Processor 302 may include a processor, a microprocessor, an Application Specific Integrated Circuit (ASIC), a Field Programmable Gate Array (FPGA), and/or other processing logic (e.g., audio/video processor) capable of processing information and/or controlling device 200. Memory 304 may include static memory, such as read only memory (ROM), and/or dynamic memory, such as random access memory (RAM), or onboard cache, for storing data and machine-readable instructions. Memory 304 may also include storage devices, such as a floppy disk, CD ROM, CD read/write (R/W) disc, and/or flash memory, as well as other types of storage devices.

Input/output components 306 may include a display screen (e.g., display 102), a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to device 200.

Network interface 308 may include any transceiver-like mechanism that enables device 200 to communicate with other devices and/or systems. For example, network interface 308 may include mechanisms for communicating via a network, such as the Internet, a terrestrial wireless network (e.g., a WLAN), a satellite-based network, a WPAN, etc. Additionally or alternatively, network interface 308 may include a modem, an Ethernet interface to a LAN, and/or an interface/connection for connecting device 200 to other devices (e.g., a Bluetooth interface).

Communication path 310 may provide an interface through which components of device 200 can communicate with one another.

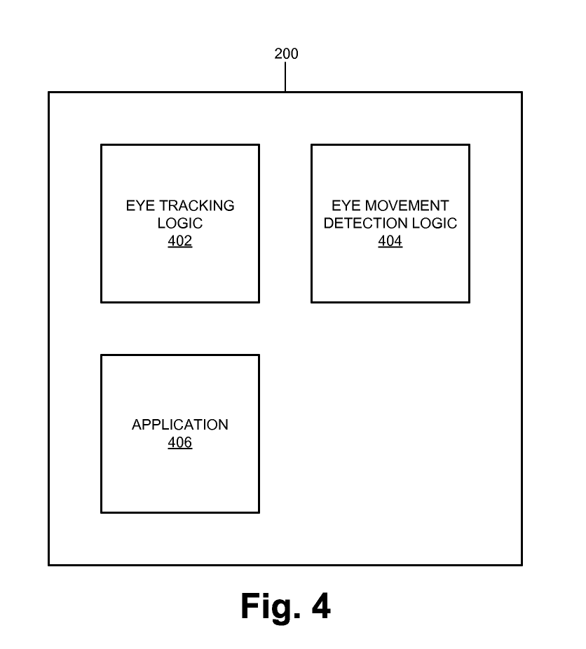

FIG. 4 is a functional block diagram of device 200. As shown, device 200 may include eye tracking logic 402, eye movement detection logic 404, and an application 406. Although not illustrated in FIG. 4, device 200 may include additional functional components, such as, for example, an operating system, additional applications, etc. Furthermore, in some implementations, the functionalities of eye tracking logic 402 and/or eye movement detection logic 404 may be incorporated in application 406.

Eye tracking logic 402 may include hardware and/or software for determining, on a display screen, a location at which a user is looking. Eye tracking logic 402 may use various techniques or mechanisms for determining the location. For example, in one implementation, eye tracking logic 402 may track a user's eye movements. In this case, eye tracking logic 402 can include, or operate in conjunction with, sensors 212 (e.g., an ultrasound sensor, an infrared sensor, etc.) and/or a camera (e.g., front camera 214) to determine movements of user's eyes.

To determine, on the display, the location at which the user looks, eye tracking logic 402 may measure a distance between the user's eyes and device 200 based on outputs from one or more sensors (e.g., sensor 212). Furthermore, eye tracking logic 402 may use the measured distance and positions of the eyes in a visual field of the camera to determine locations of the user's eyes relative to device 200. Given the relative locations of the eyes and a direction in which the eyes look, eye tracking logic 402 may determine the display location at which the user looks. In some implementations, eye tracking logic 402 may incorporate mechanisms for tracking the viewer's head, in order to obtain greater accuracy in eye tracking.

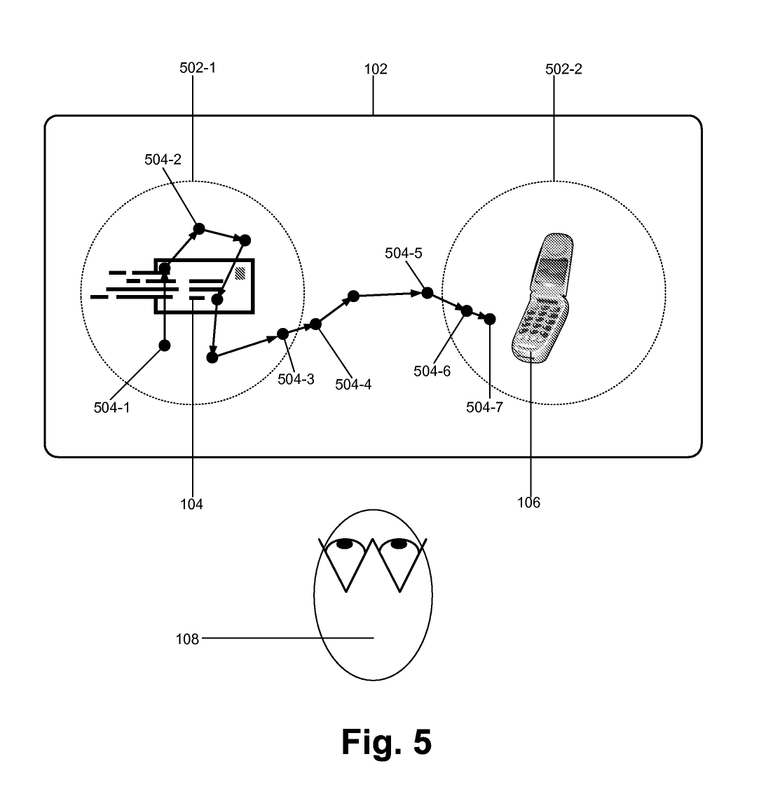

Eye movement detection logic 404 may include hardware and/or software for determining when the user's eyes look away from/to a graphical feature (e.g., graphical feature 104) on the display. FIG. 5 illustrates a process for determining, by eye movement detection logic 404, whether the user's eyes look away from/to a graphical feature.

FIG. 5 shows regions 502-1 and 502-1 (herein collectively referred to as regions 502 and individually as 502-x) and fixation points, some of which are labeled from 504-1 through 504-7 (herein collectively referred to as fixation points 507 and individually as 507-x).

Region 502-x may be associated with a graphical feature within region 502-x, and may include a set of particular points, known as “fixation points,” on display 102. When a viewer looks at a graphical feature, viewer 108's eyes may move about the graphical feature in a saccadic motion. Before or at the end of each saccadic motion, the eyes may settle on one of the fixation points in region 502-x.

Fixation point 504-x may include a point at which viewer 108's eyes temporarily fixates when viewer 108 looks at a graphical feature associated with fixation point 504-x. In addition, fixation point 504-x associated with the graphical feature may lie on the graphical feature, or outside of the graphical feature. If fixation point 504-x lies outside of the graphical feature, fixation point 504-x may be herein referred to as an “outer fixation point.” For example, fixation point 504-2 may be an outer fixation point associated with graphical feature 104.

To determine whether a viewer is looking at a graphical feature, eye movement detection logic 404 may differentiate a fixation point and a saccade. In addition, upon identifying a fixation point, eye movement detection logic 404 may evaluate whether the location of a fixation point is within a region (e.g., region 502-1) associated with the graphical feature. The fixation point may be determined by identifying a point at which viewer 108 looks for a predetermined amount of time.

For example, to determine whether viewer 108 is looking at graphical feature 104, eye movement detection logic 404 may evaluate if a fixation point (e.g., fixation point 504-2) at which viewer 108 is looking is outside of region 502-1. In some situations, such approach may be preferable to evaluating whether a fixation point lies outside of graphical feature 104, because although viewer 108 is looking at graphical feature 104, viewer 108's eyes may temporarily fixate on outer fixation points (e.g., fixation points 504-1, 504-2, etc.).

In FIG. 5, fixation points 504 are illustrated as being interconnected by a path. When viewer 108 shifts the his/her gaze from graphical feature 104 to graphical feature 106, viewer 108's eyes may traverse the path in a saccadic motion, temporarily resting at each fixation point 504-x before “jumping” to a next fixation point. During a saccade, the eyes may become temporarily unable to perceive images, and thus effectively become “blind.”

When viewer 108's eyes are on one of fixation points 504-1 through 504-3, eye movement detection logic 404 may indicate that viewer 108 is looking at graphical feature 104.

When the eyes move outside of region 502-1 (e.g., at fixation point 504-3) and eye tracking logic 402 outputs the location of the point at which the eyes are fixated, eye movement detection logic 404 may determine that the eyes are no longer looking at graphical feature 104. Furthermore, eye movement detection logic 404 may send a message and/or an event indicating the movement of the eyes to other components of device 200 (e.g., application 406, an operating system, etc.). The message may include the location (e.g., coordinates) of a point on the display at which the eyes are fixated when the beginning/end of a eye movement (e.g., saccade) is detected, the velocity of the movement, the time of the movement, and/or other data collection/bookkeeping information.

When viewer 108's eyes move to look at a point inside of region 502-2 (e.g., fixation point 504-6) and eye tracking logic 402 outputs the location of the point at which the eyes are fixated, eye movement detection logic 404 may determine that the eyes are looking at graphical feature 106. Furthermore, eye movement detection logic 404 may send a message and/or an event indicating the movement of the eyes to other components.

Returning to FIG. 4, application 406 may include a hardware and/or software components for performing a specific set of tasks. In addition, application 406 may receive outputs (e.g., messages, events, etc.) from eye movement detection logic 404 and may either highlight or stop highlighting a graphical feature.

For example, in FIG. 5, when application 406 receives a message from eye movement detection logic 404 indicating that viewer 108's eyes are looking at a fixation point within region 502-2, application 406 may highlight another graphical feature (not shown in FIG. 5). The highlighted graphical feature may provide various effects, such as a vibration, changing color, changing brightness, animation, scaling, rotation, translation, italicizing text, underlining text, bolding text, distorting the graphical feature, modifying graphical images around or about graphical feature 106, etc. If graphical feature 106 is already highlighted, application 406 may stop highlighting graphical feature 106 when application 406 receives the message.

### Exemplary Processes for Discreet Feature Highlighting

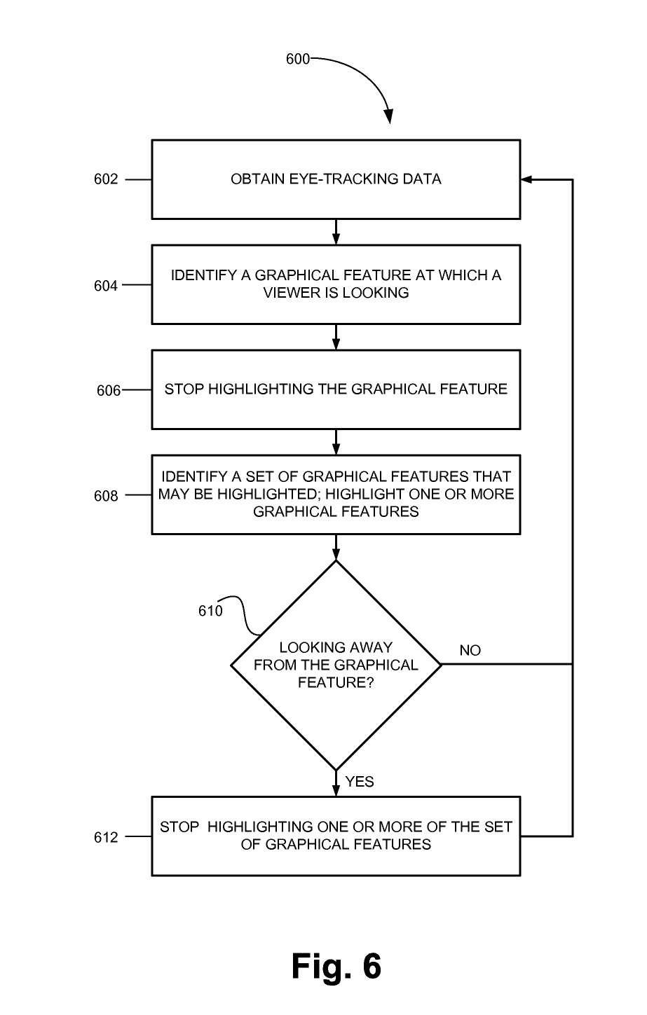

FIG. 6 is flow diagram of an exemplary process 600 for discreetly highlighting a graphical feature. Process 600 may begin at block 602, where eye tracking data may be produced (block 602). For example, eye tracking logic 402 may produce coordinates of a point, on display screen 102, at which viewer 108 may be looking.

A graphical feature at which viewer 108 is looking may be identified (block 604). For example, based on the eye tracking data (e.g., the location of the fixation point at which the user looks), eye movement detection logic 404 and/or application 406 may identify a graphical feature at which viewer 108 is looking. In some implementations, eye movement detection logic 404 and/or application 406 may identify the graphical feature by determining whether a region that is associated with the graphical feature includes a fixation point detected by the eye movement detection logic 404. In other implementations, eye movement detection logic 404 and/or application 406 may identify the graphical feature based on the area occupied by the graphical feature.

The graphical feature may stop being highlighted (block 606). For example, once the graphical feature is identified and if the graphical feature is highlighted, application 406 may stop highlighting the graphical feature. In this manner, once eye movement detection logic 404 determines that a highlighted graphical feature has been detected by viewer 108, the highlighting may no longer be needed, and application 406 may be signaled to turn off the highlighting. If the graphical feature is already not highlighted, process 600 may proceed to block 608.

A set of graphical features that are to be highlighted may be identified (block 608). For example, once eye movement detection logic 404 and/or application 406 identifies the graphical feature viewer 108 is looking at, eye movement detection logic 404 and/or application 406 may identify a set of zero or more graphical features that may be highlighted. For example, if a viewer is looking at an incorrectly spelled word, a word processing application 406 may determine that an icon whose activation will start a spelling checker needs to be highlighted. In this case, the icon to be highlighted may be dependent on the graphical feature (e.g., the incorrectly spelled word) currently being viewed. In another example, application 406 may determine whether a graphical feature includes an advertisement to which viewer 108 is likely to respond. In yet another example, application 406 may determine whether a graphical feature can provide useful information to viewer 108 when the graphical feature is activated or viewed.

After the identification, eye movement detection logic 404 and/or application 406 may cause at least one of the set of graphical features to be highlighted (block 610). Viewer 108 may perceive the highlighted graphical features via his/her peripheral vision.

In some implementations, highlighting may be fine tuned, to provide multiple visual effects. For example, to draw a viewer's attention to a particular area of a display, an animation may be used. In other instances, to momentarily increase or direct viewer 108's attention on a specific icon, a contrast between the icon and the background color may be increased.

It may be determined if viewer 108 is looking away from the graphical feature identified at block 604 (block 610). Based on the output of eye tracking logic 402, eye movement detection logic 404 and/or application 406 may determine if viewer 108 is looking away from the graphical feature. In one implementation, eye movement detection logic 404 and/or application 406 may determine that viewer 108 is looking away from the graphical feature when viewer 108 looks at a fixation point outside of a region (e.g., region 502-1) associated with the graphical feature. In a different implementation, eye movement detection logic 404 and/or application 406 may determine that viewer 108 is looking away from the graphical feature when viewer 108 looks at a fixation point outside of the graphical feature itself.

At block 610, if viewer 108 is looking away from the graphical feature, process 600 may proceed to block 612. Otherwise, process 600 may return to block 602.

At block 612, the set of graphical features identified at block 608 may no longer be highlighted (block 612). Once application 406 detects that viewer 108's eyes are no longer looking at the graphical feature, application 406 may stop highlighting the set of graphical features, to prevent the set of graphical features from being openly noticed. In other instances, only some of the set of graphical features may no longer be highlighted.

In some implementations, device 200 may track how often viewer 108 selects the highlighted graphical features. Depending on how often viewer 108 selects the highlighted graphical features, device 200 may increase the frequency of or the type of highlighting, to make it more likely that viewer 108 selects one or more of the highlighted graphical features.

### EXAMPLE

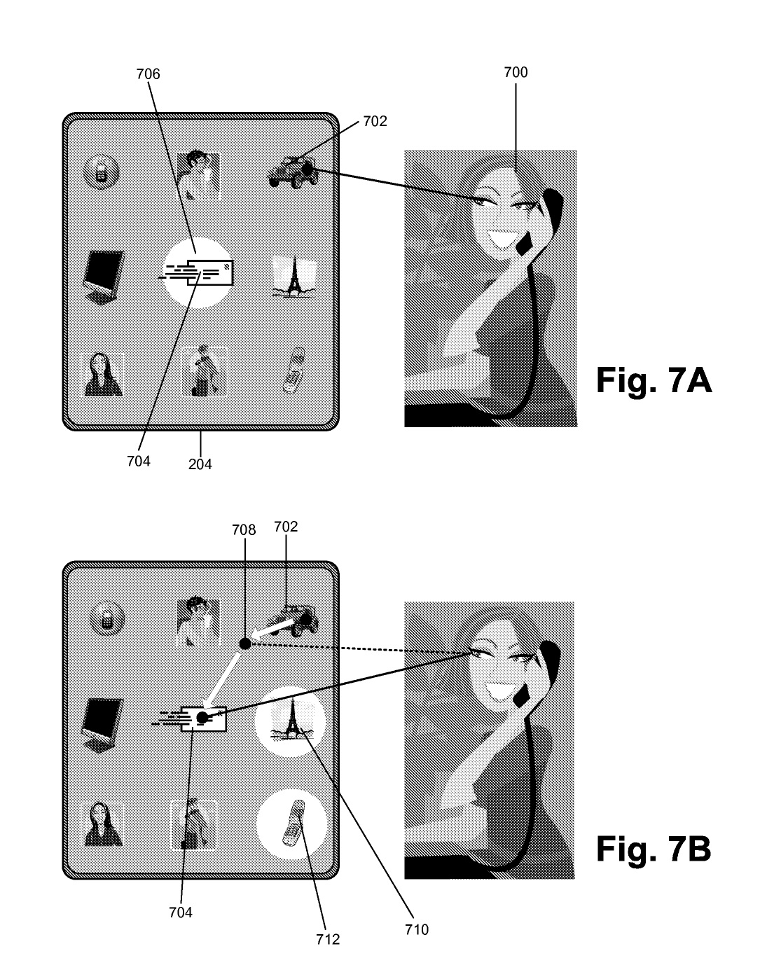

FIGS. 7A and 7B illustrate a process involved in discreetly highlighting a graphical feature. The example is consistent with exemplary process 600 described above with reference to FIG. 6.

FIG. 7A shows Elena 700 looking at display 204 of device 200 (not shown). Display 204 is not shown in scale relative to Elena. As shown in FIG. 7A, display 204 includes icons, two of which are labeled as 702 and 704.

When Elena 700 looks at icon 702, device 200 obtains eye tracking information related to Elena 700's eyes, and identifies that a graphical feature at which Elena 700 is looking is icon 702. In addition, device 200 identifies icon 704 as a graphical feature that may be highlighted, as activating icon 704 may possibly provide Elena 700 with useful information. Device 200 applies highlight 706 to icon 704. For this case, highlight 706 may be an oval or circle spotlighting or highlighting icon 704. In some instances, highlight 706 may flash, be of a bright color, etc., so that icon 704 may be more likely be noticed by Elena 700.

FIG. 7B shows Elena 700 looking away from icon 702. When Elena 700 shifts her eyes from icon 702 to a fixation point 708, as indicated by the arrows in FIG. 7B, device 200 detects the movement of Elena 700's eyes, and removes highlight 706 from icon 704. The arrows are shown in FIG. 7B for explanatory purposes only and are not visible to Elena 700.

When Elena 700 shifts her eyes from fixation point 708 to icon 704, device 200 obtains eye tracking information related to Elena 700's eyes. Device 200 also identifies icon 704 as the graphical feature at which Elena 700 is looking. Furthermore, device 200 identifies icons 710 and 712 as graphical features that may be highlighted, and proceeds to highlight icons 710 and 712.

In the above, by discreetly highlighting a graphical feature, device 200 may avoid being obtrusive, while increasing the chance of guiding the user to employ a useful/helpful feature. In some instances, graphical features may take the form of advertisements, and in such cases, device 200 may draw the user's attention to a product without interfering with user activities or annoying the user.

### Conclusion

The foregoing description of implementations provides illustration, but is not intended to be exhaustive or to limit the implementations to the precise form disclosed. Modifications and variations are possible in light of the above teachings or may be acquired from practice of the teachings.

For example, although highlighting has been described in terms of graphical features on a display, other non-display related items (e.g., LEDs, lit buttons, etc.) may be used to highlight a component (e.g., a button).

In yet another example, in one implementation, visual components (e.g., light bulbs, LEDs, etc.) may be distributed over an area larger than a display screen (e.g., a waiting room, bus stop, etc.). In such situations, the visual components may draw a user's attention to different objects (e.g., an emergency exit, a billboard carrying advertisements, etc.) or locations. In these types of settings, head tracking logic may be used in place of eye tracking logic.

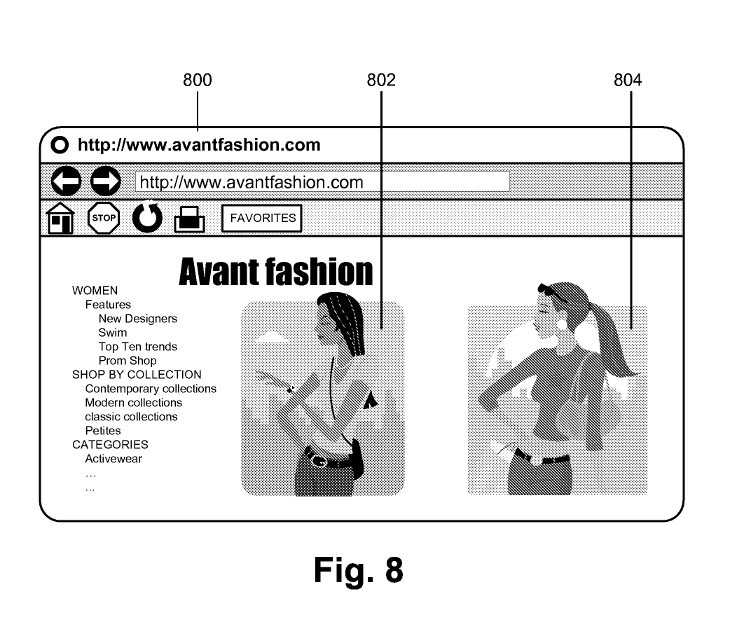

In another example, in one implementation, application 406 may be implemented as a web page, script, and/or other types of web-related data and/or program. FIG. 8 illustrates one such implementation. In FIG. 8, browser 800 shows a web page that displays two images 802 and 804. When a user looks at image 802, browser 800 may highlight image 804, which may be an image for a related item. When the user activates image 804 via a mouse or a keyboard, browser 800 may present the user with detailed information about clothes that are shown in image 804. In another implementation (not shown), device 200 (e.g., a camera) may discreetly highlight an icon for activating a blogging function. By activating the icon, the user may not only perform blogging, but also upload a picture taken by device 200 to the blogging site.

In addition, while series of blocks have been described with regard to the exemplary processes illustrated in FIG. 6, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a” is intended to include one or more items. Where one item is intended, the term “one” or similar language is used. Further, the phrase “based on” is intended to mean “based, at least in part, on” unless explicitly stated otherwise.

What is claimed is:

1. A method comprising:
identifying a first graphical feature at which a viewer is looking;
removing a highlight from the first graphical feature;
identifying at least one graphical feature to be highlighted based on a location at which the viewer is looking; and
highlighting the at least one graphical feature.

2. The method of claim 1, where highlighting the at least one graphical feature includes at least one of:
rotating the graphical feature; translating the graphical feature; scaling the graphical feature; distorting the graphical feature; changing a color of the graphical feature; or underlining, italicizing, or bolding text of the graphical feature.

3. The method of claim 1, further comprising:
obtaining eye tracking data to determine the location, on a display, at which the viewer is looking.

4. The method of claim 3, where obtaining eye tracking data includes:
tracking eyes of the viewer via a camera.

5. The method of claim 1, further comprising:
determining whether the viewer is looking away from the first graphical feature; and
removing highlights from the at least one graphical feature when the viewer is looking away from the first graphical feature.

6. The method of claim 5, where determining whether the viewer is looking away from the graphical feature includes:
determining whether the viewer is looking outside of a predetermined region in which the graphical feature lies; or
determining whether viewer is at a point outside of the graphical feature.

7. The method of claim 6, where determining whether the viewer is looking outside of a predetermined region includes:
determining whether the viewer is looking at an outer fixation point inside the region.

8. The method of claim 1, where identifying at least one graphical feature to be highlighted includes at least one of:
determining whether one of plurality of graphical features can provide useful information to the viewer when the one of plurality of graphical features is activated; or
determining whether one of plurality of graphical features is an advertisement.

9. The method of claim 1, where identifying a first graphical feature at which a viewer is looking includes:
determining whether the viewer's eyes are fixated or focused on a point within a predetermined region that includes the first graphical feature.

10. A device comprising:
a display to show one or more graphical features; and
an application to:
identify a graphical feature at which a viewer is looking,
identify at least one graphical feature to which a highlight may be applied, and
apply the highlight to the at least one graphical feature when the viewer looks away from the graphical feature.

11. The device of claim 10, where the device comprises:
a cell phone; an electronic notepad; a laptop; a personal computer; or a portable digital assistant.

12. The device of claim 10, further comprising at least one of:
a front camera to track the viewer's eyes; or
a sensor to measure a distance between the device and the viewer's eyes.

13. The device of claim 10, where the graphical feature includes at least one of:
text, an icon, an image, a menu item, or a link.

14. The device of claim 10, where the application includes a browser.

15. The device of claim 10, where the application is further configured to:
undo a highlight on the graphical feature.

16. The device of claim 10, where the application is further configured to:
apply highlights to one or more graphical features when the viewer is looking at the graphical feature.

17. The device of claim 10, further comprising:
eye tracking logic to obtain a location, on the display, of a point at which the viewer looks.

18. A method comprising:
obtaining eye tracking data;
obtaining a location at which a viewer is looking based on the eye tracking data;
identifying a component at which a viewer is looking based on the location at which the viewer is looking;
removing a highlight from the component;
identifying at least one component to be highlighted based on viewer activity or the eye tracking data;
determining whether the viewer is looking away from the component; and
removing highlights from the at least one component when the viewer is looking away from the component.

19. The method of claim 18, where the component includes:
an emergency exit or a billboard.

20. The method of claim 18, where obtaining eye tracking data includes:
obtaining head tracking data.
